(19) United States
(12) Patent Application Publication
(10) Pub. No.: US 2013/0002756 A1
(43) Pub. Date: Jan. 3, 2013

(54) WIPER SYSTEM

(76) Inventor: Adrian Kriz, Corvallis, OR (US)

(21) Appl. No.: 13/170,946

(22) Filed: Jun. 28, 2011

(51) Int. Cl. B41J 2/165; B05C 17/00; B05C 17/10

(52) U.S. Cl. 347/33; 15/118; 15/209.1

(57) ABSTRACT

A wiping system is disclosed. The wiping system has a wiper blade and a web wipe. The wiper blade forms an angle with the surface to be cleaned. The wiper blade has a tip formed in the front end of the wiper blade. The wiper blade moves in a wiping direction with the front end leading the rest of the blade when the wiper blade is moving in the wiping direction. The web wipe is placed between the tip and the surface to be cleaned, with the web wipe contacting both the tip and the surface to be cleaned.

### BACKGROUND

Current wiper systems may have difficulties cleaning an inkjet printhead in areas that have high topography or non-flat surfaces. One example of an area of an inkjet printhead that has high topography or non-flat surfaces is the die-to-flex circuit interconnect and adhesive joint. Typical wiper geometries can not reach into the base of the interconnect area and thus do not clean out the debris that accumulates at these locations.

### BRIEF DESCRIPTION OF THE DRAWINGS

FIG. 1 is a block diagram of a wiper system 100 in an example embodiment of the invention.

FIG. 2 is a side view of wiper blade 104 in an example embodiment of the invention.

FIG. 3 is a side view of a dual bladed wiping system 300 in an example embodiment of the invention.

### DETAILED DESCRIPTION

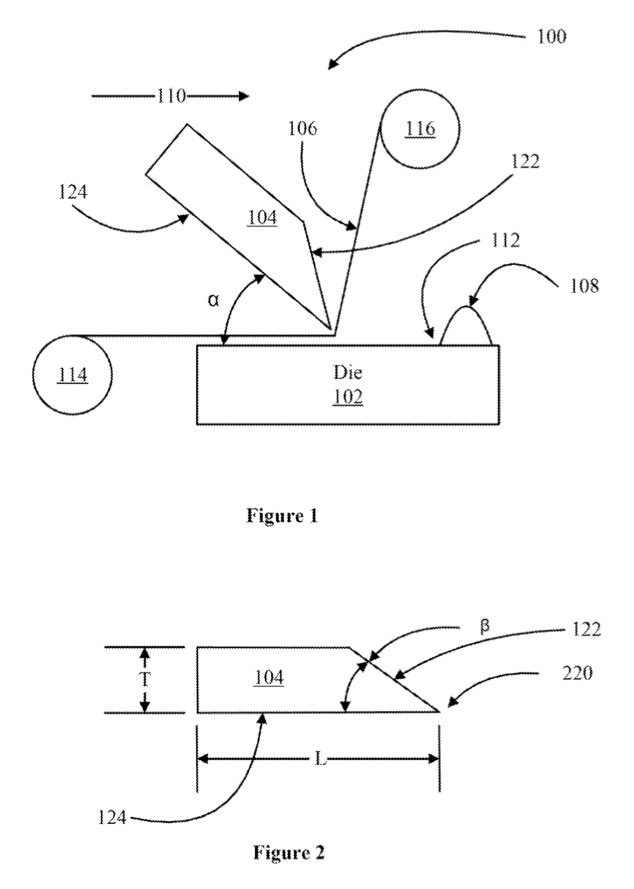

FIGS. 1-3, and the following description depict specific examples of the invention. For the purpose of teaching inventive principles, some conventional aspects have been simplified or omitted. Those skilled in the art will appreciate variations from these examples that fall within the scope of the invention. The features described below can be combined in various ways to form multiple variations of the invention. As a result, the invention is not limited to the specific examples described below, but only by the claims and their equivalents.

FIG. 1 is a block diagram of a wiper system 100 in an example embodiment of the invention. Wiper system 100 comprises wiper blade 104, web wipe 106, take-up roller 116 and supply roller 114. Wiper blade 104 is made from a flexible material, for example rubber, silicone, or the like. Web wipe 106 is constructed from an absorbent web fabric or the like. Wiper system 100 is positioned by a die 102, for example a die for an inkjet print head. Die 102 has a step in height on the right side of die 102. The step or variation in height could be due to a number of features on the die, for example an electrical interconnect encapsulent 108. As the inkjet print head is used, ink may accumulate on the top surface of the die 102. Traditional wiping systems may have difficulty cleaning the surface of die 102 in areas that have varying heights, for example where the adhesive encapsulant of the electrical interconnect meets the top surface of the die (area 112).

The wiping system 100 is configured to clean areas on the die that have difficult to clean topography or topology like area 112. The bottom side 124 of wiper blade 104 forms and angle alpha (α) with the top surface of die 102. Angle α may be between 10 degrees and 80 degrees, for example 45 degrees. The front end of wiper blade 104 is formed into a tip 220 (see FIG. 2). The angle and/or thickness of wiper blade 104 are adjusted such that the wiper maintains an acute (chisel-like) angle with the surface of the die and does not buckle during the wiping motion. The tip 220 of wiper blade is forced against the top side of die 102. Web wipe 106 is positioned between the tip 102 and the top side of die 102, contacting both the tip and the top surface of die 102. For clarity, FIG. 1 shows space between the wiper blade tip, the web wipe 106 and the top surface of die 102.

Wiper system 100 moves in a wiping direction as shown by arrow 110. When wiper system 100 is moving in the wiping direction, the front end of the wiper blade 104 goes first and the tip scrapes the top of the die 102. The tip of the wiper blade 104 fits well into the areas of high topography area (112). When wiper system 100 is moving in the wiping direction, web wipe 106 moves with wiping blade 104. Web wipe 106 prevents the tip of wiper blade from sticking on the top of die 102. In addition, web wipe 106 wicks and absorbs the ink from the top of die 102 to aid in servicing the TIJ nozzles.

In one example embodiment of the invention, wiping system 100 may remain in contact with the top surface of die 102 as it retracts in the opposite direction from the wiping direction. In other example embodiments, wiping system 100 may be raised away from the top surface of die 102 before being retracted. Alternate embodiments could include a spring mechanism to allow the rubber wiper to absorb even higher levels of topology without buckling.

Supply roller 114 contains a supply of web wipe 106. A portion of web wipe 106 extends from supply roller 114 to take-up roller 116. Web wipe 106 may be advanced from supply roller 114 to take-up roller 116 after some number of wipes. Each time web wipe is advanced from supply roller 114 to take-up roller 116 a new/clean section of web wipe will be adjacent to the tip 220 of wiper blade 104. Web wipe 106 may be advanced after each wipe, or after some number of wipes, for example 2 to 20 wipes. The position of the supply roller 114 and take-up roller 116 can be swapped. Alternate embodiments include having the web material in a continuous loop (belt) that is reused instead of a reel-to-reel system.

FIG. 2 is a side view of wiper blade 104 in an example embodiment of the invention. Wiper blade 104 has a bottom side 124 and a front face 122. The front face makes an angle β with respect to the bottom side. Angle β may be between 15 degrees and 90 degrees, for example 30 degrees. In one example embodiment of the invention the sum of angle α and angle β will be between 60 and 100 degrees, for example 85 degrees. Wiper blade has a length L and a thickness T. Length L may be between 0.5 cm and 3 cm, for example 1 cm in length. Thickness T may be between 0.1 and 2 cm, for example 0.5 cm thick. A tip 220 is formed on the front end of wiper blade 104. The tip 220 may form a point or may end in a radius.

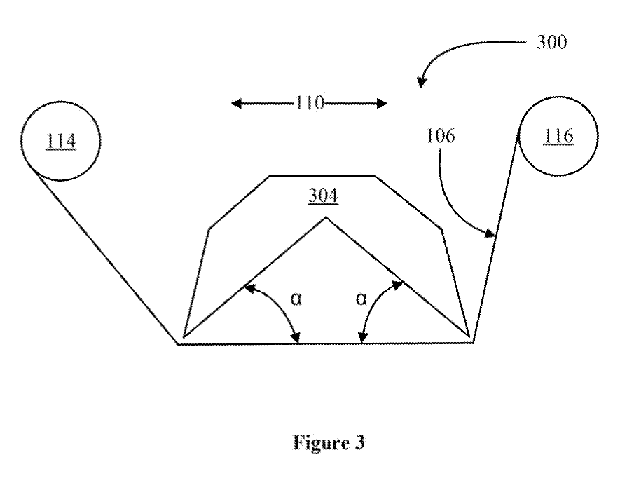

FIG. 3 is a side view of a dual bladed wiping system 300 in an example embodiment of the invention. Dual bladed wiping system 300 comprises wiper blade 304, web wipe 106, take-up roller 116 and supply roller 114. Wiper blade 304 has two tips for wiping in both directions (as shown by arrow 110). Wiper blade 104 is made from a flexible material, for example rubber, silicone, or the like. Web wipe 106 is constructed from an absorbent web fabric or the like. The two bottom sides of wiper blade 304 form and angle alpha (α) with the top surface of a die (not shown, but parallel with the web wipe 106 between the two tips). Angle α may be between 10 degrees and 80 degrees, for example 45 degrees. Each end of wiper blade 304 is formed into a tip. The angle and/or thickness of each end of wiper blade 304 are adjusted such that the wiper maintains an acute (chisel-like) angle with the surface of the die and does not buckle during the wiping motion. Both tips of wiper blade 302 are forced against the top side of a die (not shown). Web wipe 106 is positioned between the two tips and the top side of the die (not shown), contacting both the tips and the top surface of the die. For clarity, FIG. 1 shows space between the wiper blade tips, and the web wipe 106.

Wiper system 300 moves in two wiping direction as shown by arrow 110. When wiper system 300 is moving in the first wiping direction (to the right), the right side of the wiper blade 304 goes first and the right tip scrapes the top of a die. The tip of the wiper blade 304 fits well into the areas of high topography area. When wiper system 300 is moving in the second (opposite) wiping direction (to the left), the left side of the wiper blade 304 goes first and the left tip scrapes the top of a die. The tips of the wiper blade 304 fit well into the areas of high topography area. When wiper system 300 is moving in either wiping direction, web wipe 106 moves with wiping blade 304. Web wipe 106 prevents the tips of wiper blade from sticking on the top of the die. In addition, web wipe 106 wicks and absorbs the ink from the top of the die to aid in servicing the TIJ nozzles.

What is claimed is:

1. A wiper system for cleaning a surface of a die, comprising:
a wiper blade having a tip formed in a front end of the wiper blade, a bottom side of the wiper blade forming an angle α with the surface of the die, the wiper blade configured to move in a first wiping direction wherein the front end leads the wiper blade when the wiper blade moves in the first wiping direction;
a web wipe positioned between the tip and the die, the web wipe contacting both the tip and the surface of the die when the wiper blade is moving in the first wiping direction, the web wipe moving with the wiper blade when the wiper blade moves in the first wiping direction.

2. The wiper system for cleaning a die of claim 1, further comprises:
a supply roller and a take-up roller wherein the supply roller has a supply of the web wipe and a portion of the web wipe extends from the supply roller to the take-up roller, wherein a portion of the web wipe is advanced from the supply roller to the take-up roller after a predetermined number of wipes.

3. The wiper system for cleaning a die of claim 2, wherein the predetermined number of wipes between each advance of the web wipe is an integer from 1 to 20 wipes.

4. The wiper system for cleaning a die of claim 1, further comprises:
a continuous loop/belt of web wipe that is re-used, wherein a portion of the web wipe is advanced in the loop after a predetermined number of wipes.

5. The wiper system for cleaning a die of claim I, wherein the wiper blade is fabricated from a flexible material.

6. The wiper system for cleaning a die of claim 1, wherein the angle α is between 10 degrees and 80 degrees.

7. The wiper system for cleaning a die of claim I, wherein a front face of the wiper blade makes an angle β with the bottom side of the wiper blade and angle β is between 15 degrees and 90 degrees.

8. The wiper system for cleaning a die of claim 7, wherein the sum of angle α and angle β is between 60 and 100 degrees.

9. The wiper system for cleaning a die of claim 1, wherein wiper blade moves in a retraction direction that is in the opposite direction from the wiping direction, wherein the wiper blade and the web wipe are lifted from the die surface before the wiper system is moved in the retraction direction.

10. The wiper system for cleaning a die of claim 1, further comprises:
a second tip formed in a back end of the wiper blade, the wiper blade configured to move in a second wiping direction opposite from the first wiping direction wherein the back end leads the wiper blade when the wiper blade moves in the second wiping direction.

11. An inkjet printer, comprising:
an inkjet print head, the inkjet printhead containing at least one die; the die having a surface;
a wiper blade having a tip formed in a front end of the wiper blade, a bottom side of the wiper blade forming an angle α with the die surface, the wiper blade configured to move in a wiping direction parallel with the die surface, wherein the front end leads the wiper blade when the wiper blade moves in the wiping direction;
a web wipe positioned between the tip and the die surface, the web wipe contacting both the tip and the die when the wiper blade is moving in the wiping direction, the web wipe moving with the wiper blade when the wiper blade moves in the wiping direction.

12. The inkjet printer of claim 11, wherein the angle α is between 10 degrees and 80 degrees.

13. The inkjet printer of claim 11, wherein a front face of the wiper blade makes an angle β with the bottom side of the wiper blade and angle β is between 15 degrees and 90 degrees.

14. The inkjet printer of claim 13, wherein the sum of angle α and angle β is between 60 and 100 degrees.

15. The inkjet printer of claim 11, further comprises:
a supply roller and a take-up roller wherein the supply roller has a supply of the web wipe and a portion of the web wipe extends from the supply roller to the take-up roller, wherein a portion of the web wipe is advanced from the supply roller to the take-up roller after a predetermined number of wipes.

16. A wiper system comprising:
a means for wiping, the means for wiping having a tip, the means for wiping configured to move in a wiping direction parallel to a surface to be cleaned, wherein the tip leads the way when the wiping means moves in the wiping direction;
an absorption means, the absorption means located between the tip and the surface to be cleaned, the absorption means contacting both the tip and the surface to be cleaned.
